(19) United States
(12) Patent Application Publication
(10) Pub. No.: US 2024/0269694 A1
(43) Pub. Date: Aug. 15, 2024

(54) FIVE-IN-ONE ROTARY PRESSURE WASHER NOZZLE

(71) Applicants: Juan Ehringer, GAINESVILLE, FL (US); Chris Wilson, GAINESVILLE, FL (US)

(72) Inventors: Juan Ehringer, GAINESVILLE, FL (US); Chris Wilson, GAINESVILLE, FL (US)

(21) Appl. No.: 18/110,059

(22) Filed: Feb. 15, 2023

(51) Int. Cl. B05B 1/16

(52) U.S. Cl. CPC B05B 1/1654; B05B 1/169

(57) ABSTRACT

An improved rotary nozzle may include a primarily metal assembly including a plurality of removable nozzles. The rotary nozzle may include a first body connectable to a pressure washer hose or similar fluid source, as well as a second body rotatably connected to the first body to allow for selection of a nozzle without the need for removal of a first nozzle and installation of a second nozzle. The rotary nozzle may include four or more selectable nozzles allowing for quick transitions between spray patterns when in use.

### TECHNICAL FIELD

The embodiments generally relate to the field of nozzles through which fluid may flow.

### BACKGROUND

Rotary nozzles attachable to power washers and the like commonly include fixed nozzles and plastic components prone to cracking or early failure.

Non-rotary nozzle attachable to power washers require tedious storage and time-consuming effort to change nozzles during use.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the disclosed rotary nozzle may include a primarily metal assembly including a plurality of removable nozzles. The rotary nozzle may include a first body connectable to a pressure washer hose or similar fluid source, as well as a second body rotatably connected to the first body to allow for selection of a nozzle without the need for removal of a first nozzle and installation of a second nozzle.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates an illustrative depiction of a five-in-one rotary pressure washer nozzle as disclosed herein;

FIG. 2 illustrates an illustrative depiction of a five-in-one rotary pressure washer nozzle as disclosed herein; and

FIG. 3 illustrates an illustrative depiction of a five-in-one rotary pressure washer nozzle as disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described product or methods of use. Any specific details of the embodiments are used for demonstration purposes only and no unnecessary limitations or inferences are to be understood from there.

It is noted that the embodiments reside primarily in combinations of components and procedures related to the products. Accordingly, the product and components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a rotary nozzle that may include a primarily metal assembly including a plurality of removable nozzles. The rotary nozzle may include a first metal body connectable to a pressure washer hose or similar fluid source. The first metal body may include an integrated adapter constructed and arranged to attach to a fluid source. As a non-limiting example, the integrated adapter may be of the ball lock fitting or snap lock fitting type constructed and arranged to attach to a hose providing water or other fluid to the rotary nozzle. The first metal body may include at least one recess constructed and arranged to facilitate rotation of the second metal body relative to the first metal body.

The second metal body may be rotatably connected to the first body to allow for selection of a nozzle without the need for removal of a first nozzle and installation of a second nozzle. The second metal body may include a plurality of threaded through holes constructed and arranged to receive pressure washer nozzles therein. The second body may include a textured outer surface to facilitate rotation of the second metal body relative to the first metal body to allow for selection of a pressure washer nozzle.

The disclosed rotary nozzle may include NPT threaded holes to receive NPT threaded nozzles therein. According to some embodiments, the first body and second body may be made of aluminum or stainless steel. According to some embodiments, the rotary nozzle may be capable of transferring 2 or more gallons per minute of fluid, with seals capable of withstanding at least 3000 PSI.

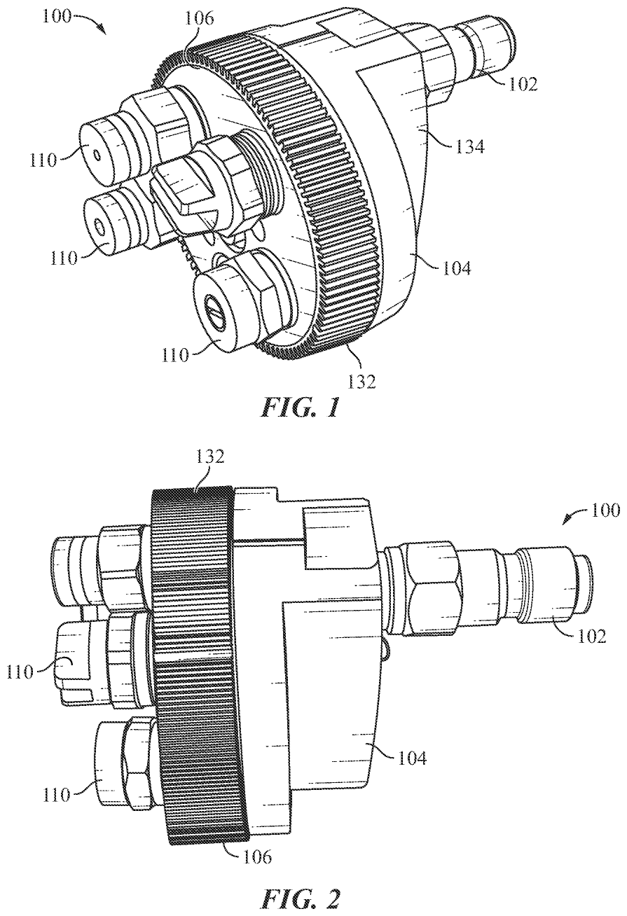

Referring to FIGS. 1 and 2, a rotary nozzle 100 may include a first body 104 including at least one recess 134 constructed and arranged to facilitate rotation of the second body 106 relative to the first body 104 and to reduce the weight of the first body 104. The first body 104 may include an integrated adapter 102 constructed and arranged to attach to a fluid source. The second body 106 may include a textured surface 132, such as ribs, protrusions, or indents, to facilitate rotation of the second body 106 relative to the first body 104. The second body 106 may receive a plurality of pressure washer nozzles therein. The integrated adapter 102 may be removably attached to the first body 104.

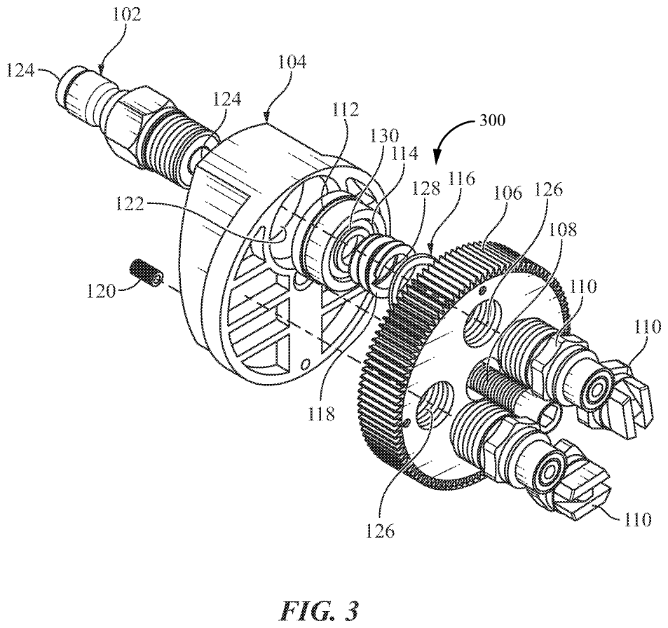

Referring to FIG. 3, a rotary nozzle 100 may include a first body 104 rotatably attached to a second body 106, the second body 106 being rotatable relative to the first body 104. The first body 104 may include an adapter 102, which may be integrated with the first body 104 or threadingly attached to the first body 104. The adapter 102 may define a first through channel 124 to allow fluid flow therethrough and into the first body 104, second body 10c, and nozzle 110, among other components.

The first body 104 may define a second through channel 122 in fluid communication with the first through channel 124. The first body 104 may include a set screw 120 constructed and arranged to temporarily lock the second body 106 in position relative to the first body 104. The set screw 120 compresses a spring and pin system, that allows the unit to ‘click’ into each position during rotation.

The second body 106 may include a plurality of nozzle through holes 126 constructed and arranged to receive a plurality of nozzles 110 therein. A center bolt 108 may rotatably fix the second body 106 to the first body 104.

A center assembly 300 may include a gate 114 defining a third through hole 130 and which may include at least one o-ring 112 to facilitate a water tight connection between the center assembly 300 and the second through channel 122 when the center assembly 300 is seated within the second through channel 122. The center assembly 300 may include a biasing member 128, such as a compression spring, and a forward sealing o-ring 116 to facilitate a water tight connection between the center assembly 300 and the first body 106 and any of the plurality of nozzle through holes 126.

In practice and in use, the second body 106 may be rotated relative to the first body 104 such that any of the plurality of nozzles 110 may be aligned with the nozzle through holes 126, third through hole 131, second through channel 122, and first through channel 124 to allow fluid to pass therethrough.

FIG. 3 depicts a rotary nozzle having four selectable spray nozzles and corresponding nozzle through holes, however, it is contemplated that the rotary nozzle may include any number of selectable spray nozzles and corresponding nozzle through holes, such as, but not limited to, two, three, four, five, or six or more.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a rotatable nozzle may include a first body including an adapter defining a first through channel, wherein the first body defines a second through channel in fluid communication with the first through channel; a second body defining a plurality of nozzle through holes constructed and arranged to receive a plurality of nozzles; a center bolt constructed and arranged to rotatably fix the second body to the first body; and a center assembly including a gate defining a third through hole, at least one rear o-ring, a biasing member, and a forward sealing o-ring, wherein the center assembly is constructed and arranged to provide a fluid-tight through channel for a flow of fluid from the first through channel, the second through channel, the third through hole, and the plurality of nozzle through holes.

Variation 2 may include a rotatable nozzle as in variation 1, further including at least one nozzle attachable to at least one of the plurality of nozzle through holes.

Variation 3 may include a rotatable nozzle as in variation 1 or 2, further including a plurality of nozzles attachable to at least one of the plurality of nozzle through holes.

Variation 4 may include a rotatable nozzle as in any of variations 1 through 3, wherein the adapter is integrated with the first body.

Variation 5 may include a rotatable nozzle as in any of variations 1 through 4, wherein the adapter is attached to the first body via a threaded connection.

Variation 6 may include a rotatable nozzle as in any of variations 1 through 5, wherein the at least one rear o-ring is constructed and arranged to facilitate a water tight connection between the center assembly and the second through channel.

Variation 7 may include a rotatable nozzle as in any of variations 1 through 6, wherein the biasing member includes a compression spring.

Variation 8 may include a rotatable nozzle as in any of variations 1 through 7, wherein the forward sealing o-ring is constructed and arranged to facilitate a water tight connection between the center assembly and the first body.

Variation 9 may include a rotatable nozzle as in any of variations 1 through 8, further including a set screw constructed and arranged to temporarily lock the second body in position relative to the first body. The set screw comprises a spring and pin system, that allows the unit to ‘click’ into each position during rotation.

Variation 10 may include a rotatable nozzle as in any of variations 1 through 9, wherein the first body includes at least one of aluminum or stainless steel. The first body and/or the second body may also be made of a hard engineering plastic such as, for example, Delrin.

Variation 11 may include a rotatable nozzle as in any of variations 1 through 10, wherein the second body includes at least one of aluminum or stainless steel.

Variation 12 may include a rotatable nozzle as in any of variations 1 through 11, wherein the rotary nozzle nozzle may be capable of transferring 2 or more gallons per minute of fluid, with seals capable of withstanding at least 3000 PSI.

Variation 13 may include a rotatable nozzle as in any of variations 1 through 12, wherein the rotary nozzle is constructed and arranged to be capable of up to six-thousand pounds per square inch of output pressure.

According to variation 14, a rotary nozzle may include a first body including an adapter defining a first through channel, wherein the first body defines a second through channel in fluid communication with the first through channel; a second body defining five nozzle through holes constructed and arranged to receive a plurality of nozzles; a center bolt constructed and arranged to rotatably fix the second body to the first body; a group of five nozzles each attached to the five nozzle through holes; and a center assembly including a gate defining a third through hole, at least one rear o-ring, a biasing member, and a forward sealing o-ring, wherein the center assembly is constructed and arranged to provide a fluid-tight through channel for a flow of fluid from the first through channel, the second through channel, the third through hole, the group of five nozzle through holes, and at least one of the five nozzles.

Variation 15 may include a rotatable nozzle as in variation 14, wherein each nozzle within the group of five nozzles is constructed and arranged to provide different distinct fluid spray patterns.

Variation 16 may include a rotatable nozzle as in any of variations 14 through 15, wherein the rotary nozzle is constructed and arranged to output at least approximately eight gallons per minute as well as being constructed and arranged to output as low as two gallons per minute.

Variation 17 may include a rotatable nozzle as in any of variations 14 through 16, wherein the rotary nozzle is constructed and arranged to be capable of at least six-thousand pounds per square inch of output pressure.

Variation 18 may include a rotatable nozzle as in any of variations 14 through 17, further including a set screw constructed and arranged to temporarily lock the second body in position relative to the first body. The set screw compresses a spring and pin system, that allows the unit to ‘click’ into each position during rotation.

According to variation 19, a rotatable nozzle may include a first body including an adapter defining a first through channel, wherein the first body defines a second through channel in fluid communication with the first through channel; a second body defining five nozzle through holes constructed and arranged to receive a plurality of nozzles; a center bolt constructed and arranged to rotatably fix the second body to the first body; a group of five nozzles each attached to the five nozzle through holes, each nozzle being constructed and arranged to provide a distinct fluid spray pattern; a center assembly including a gate defining a third through hole, at least one rear o-ring, a biasing member, and a forward sealing o-ring, wherein the center assembly is constructed and arranged to provide a fluid-tight through channel for a flow of fluid from the first through channel, the second through channel, the third through hole, the group of five nozzle through holes, and at least one of the five nozzles; and a set screw constructed and arranged to temporarily lock the second body in position relative to the first body; and wherein the rotary nozzle is constructed and arranged to be capable of at least six-thousand pounds per square inch of output pressure and is constructed and arranged to output at least approximately eight gallons per minute.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

I/We claim:

1. A rotatable nozzle comprising:
a first body comprising an adapter defining a first through channel, wherein the first body defines a second through channel in fluid communication with the first through channel;
a second body defining a plurality of nozzle through holes constructed and arranged to receive a plurality of nozzles;
a center bolt constructed and arranged to rotatably fix the second body to the first body; and
a center assembly comprising a gate defining a third through hole, at least one rear o-ring, a biasing member, and a forward sealing o-ring, wherein the center assembly is constructed and arranged to provide a fluid-tight through channel for a flow of fluid from the first through channel, the second through channel, the third through hole, and the plurality of nozzle through holes.

2. A rotatable nozzle as in claim 1, further comprising at least one nozzle attachable to at least one of the plurality of nozzle through holes.

3. A rotatable nozzle as in claim 1, further comprising a plurality of nozzles attachable to at least one of the plurality of nozzle through holes.

4. A rotatable nozzle as in claim 1, wherein the adapter is integrated with the first body.

5. A rotatable nozzle as in claim 1, wherein the adapter is attached to the first body via a threaded connection.

6. A rotatable nozzle as in claim 1, wherein the at least one rear rubber seal is constructed and arranged to facilitate a water tight connection between the center assembly and the second through channel.

7. A rotatable nozzle as in claim 1, wherein the biasing member comprises a compression spring.

8. A rotatable nozzle as in claim 1, wherein the forward sealing rubber seal is constructed and arranged to facilitate a water tight connection between the center assembly and the first body.

9. A rotatable nozzle as in claim 1, further comprising a set screw constructed and arranged to temporarily lock the second body in position relative to the first body.

10. A rotatable nozzle as in claim 1, wherein the first body comprises at least one of aluminum or stainless steel.

11. A rotatable nozzle as in claim 1, wherein the second body comprises at least one of aluminum or stainless steel.

12. A rotatable nozzle as in claim 1, wherein the rotary nozzle is constructed and arranged to output approximately between 2-12 gallons per minute.

13. A rotatable nozzle as in claim 1, wherein the rotary nozzle is constructed and arranged to be capable of at least six-thousand pounds per square inch of output pressure.

14. A rotatable nozzle comprising:
a first body comprising an adapter defining a first through channel, wherein the first body defines a second through channel in fluid communication with the first through channel;
a second body defining at least four nozzle through holes constructed and arranged to receive a plurality of nozzles;
a center bolt constructed and arranged to rotatably fix the second body to the first body;
a group of at least four nozzles each attached to the at least four nozzle through holes; and
a center assembly comprising a gate defining a third through hole, at least one rear o-ring, a biasing member, and a forward sealing o-ring, wherein the center assembly is constructed and arranged to provide a fluid-tight through channel for a flow of fluid from the first through channel, the second through channel, the third through hole, the group of at least four nozzle through holes, and at least one of the at least four nozzles.

15. A rotatable nozzle as in claim 14, wherein each nozzle within the group of at least four nozzles is constructed and arranged to provide a distinct fluid spray pattern.

16. A rotatable nozzle as in claim 14, wherein the rotary nozzle is constructed and arranged to output at least approximately eight gallons per minute.

17. A rotatable nozzle as in claim 14, wherein the rotary nozzle is constructed and arranged to be capable of at least six-thousand pounds per square inch of output pressure.

18. A rotatable nozzle as in claim 14, further comprising a set screw constructed and arranged to temporarily lock the second body in position relative to the first body.

19. A rotatable nozzle comprising:
a first body comprising an adapter defining a first through channel, wherein the first body defines a second through channel in fluid communication with the first through channel;
a second body defining at least four nozzle through holes constructed and arranged to receive a plurality of nozzles;
a center bolt constructed and arranged to rotatably fix the second body to the first body;
a group of at least four nozzles each attached to the at least four nozzle through holes, each nozzle being constructed and arranged to provide a distinct fluid spray pattern;
a center assembly comprising a gate defining a third through hole, at least one rear o-ring, a biasing member, and a forward sealing o-ring, wherein the center assembly is constructed and arranged to provide a fluid-tight through channel for a flow of fluid from the first through channel, the second through channel, the third through hole, the group of at least four nozzle through holes, and at least one of the at least four nozzles; and
a set screw constructed and arranged to temporarily lock the second body in position relative to the first body; and
wherein the rotary nozzle is constructed and arranged to be capable of at least six-thousand pounds per square inch of output pressure and is constructed and arranged to output at least approximately eight gallons per minute.
